(19) United States
(12) Patent Application Publication
(10) Pub. No.: US 2025/0039568 A1
(43) Pub. Date: Jan. 30, 2025

(54) SYSTEMS AND METHODS FOR IMPLEMENTING SOFTWARE-DEFINED CAMERAS

(71) Applicant: Wisconsin Alumni Research Foundation, Madison, WI (US)

(72) Inventors: Mohit Gupta, Madison, WI (US); Varun Sundar, Madison, WI (US)

(21) Appl. No.: 18/788,025

(22) Filed: Jul. 29, 2024

Related U.S. Application Data
(60) Provisional application No. 63/516,130, filed on Jul. 27, 2023.

(51) Int. Cl. H04N 25/47; H04N 23/743; H04N 25/773

(52) U.S. Cl. CPC H04N 25/47; H04N 23/743; H04N 25/773

(57) ABSTRACT

Methods and systems are provided for generating images of a modality other than the modality of the sensor from which the image was acquired. For example, methods and systems described herein may acquire a temporal sequence of frame data captured by the image sensor. Once the temporal sequence of frame data is acquired, a desired imaging modality may be determined and a projection operation on the frame data may be performed. Based on the results of the projection operation, a post-capture emulation may be generated, corresponding to the desired imaging modality. An image may be outputted corresponding to the post-capture emulation.

### CROSS-REFERENCE TO RELATED APPLICATION(S)

The present application is based on, claims priority to, and incorporates herein by reference in its entirety for all purposes, U.S. Provisional Patent Application Ser. No. 63/516,130, filed Jul. 27, 2023.

### STATEMENT OF GOVERNMENT SUPPORT

This invention was made with government support under 2107060 awarded by the National Science Foundation. The government has certain rights in the invention.

### TECHNICAL FIELD

The systems, methods, embodiments, and novel concepts discussed herein relate generally to processing of data obtained by cameras and other similar sensors. In some respects, certain embodiments may achieve distinctly improved image generation and/or distinctly improved image modality emulation capabilities.

### BACKGROUND

In the field of imaging (including, e.g., photography and videography as well as associated sensing technologies and cameras), sensing technologies (e.g., the sensor hardware that captures data of a scene) and the corresponding processing of that data have developed hand-in-hand. As the need for more specialized forms of images has arisen, more complex and specialized sensing technologies emerged. In other words, the need for new types of images has driven development of new hardware to generate those images.

The advent of digital cameras provided the ability to process captured data at the granularity of pixels and paved the way for modern computer vision. Optical, or “light field” cameras, by sampling the plenoptic function, allowed post-capture processing at the granularity of light rays, enabling functionalities such as refocusing photos after-capture. However, even the capabilities unlocked by digital camera sensing have, thus far, been limited to augmentation or modification of an image capture in ways that still remain within the original image modality of the sensor. For example, conventional optical images can be modified in post processing to alter colors, improve focus, etc.—but the images still remain the same optical modality; in other words, modified conventional images are still conventional images. In the current state of the field, if a different modality is desired (e.g., an event camera, a motion camera, a video compressive system, etc.), then a different camera must be used. In other words, for existing technologies the type of camera modality used to acquire an image dictates the type of image that can be obtained. Thus, where an application exists that would benefit from more than one type of camera modality, utilizing multiple cameras is the current standard.

However, it may be advantageous to have a single camera that can emulate multiple types of cameras (e.g., the camera's output can be reinterpreted as output of a different type of camera) without having to add multiple types of image sensors to the camera.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating a system for reinterpreting images according to some embodiments.

FIG. 2 is a block diagram conceptually illustrating a device for generating emulated-camera images according to some embodiments.

FIG. 3 is a flow diagram illustrating an example process for generating varying types of images according to some embodiments.

FIG. 4 is a flow diagram illustrating an example process for generating images emulating video compressive sensing according to some embodiments.

FIG. 5 is a flow diagram illustrating an example process for generating images emulating an event camera according to some embodiments.

FIG. 6 is a flow diagram illustrating an example process for generating images emulating a motion camera according to some embodiments.

FIG. 7 illustrates certain concepts of device design, data flow, and output of an example embodiment.

FIG. 8 illustrates an example of various output image results according to some embodiments.

FIG. 9 is a conceptual illustration of 1, 2, and 4 bucket binary masks, according to some embodiments.

FIG. 10 is a plot of output of various settings of an emulated event camera capture according to some embodiments.

FIG. 11 depicts example outputs of an emulated motion camera capture according to some embodiments.

FIG. 12 depicts example outputs of an emulated motion camera capture according to some embodiments.

FIG. 13 depicts example outputs of an emulated motion camera capture according to some embodiments.

FIG. 14 depicts a set of example outputs of an emulated motion camera capture according to some embodiments.

FIG. 15 depicts example outputs of various embodiments implementing an emulated event camera capture according to some embodiments.

FIG. 16 depicts example outputs of various embodiments implementing both an emulated event camera capture and an emulated video compressive sensing camera according to some embodiments.

FIG. 17 is a graph showing bandwidth and power consumption for various features of the present disclosure, as implemented via a given hardware device.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details. In some instances, well-known structures and components are shown in block diagram form to avoid obscuring such concepts. Likewise, while certain advantages of the systems and methods described herein are highlighted, it should be recognized that additional advantages may flow from use of these systems and methods even though not stated herein.

### Example Hardware Systems

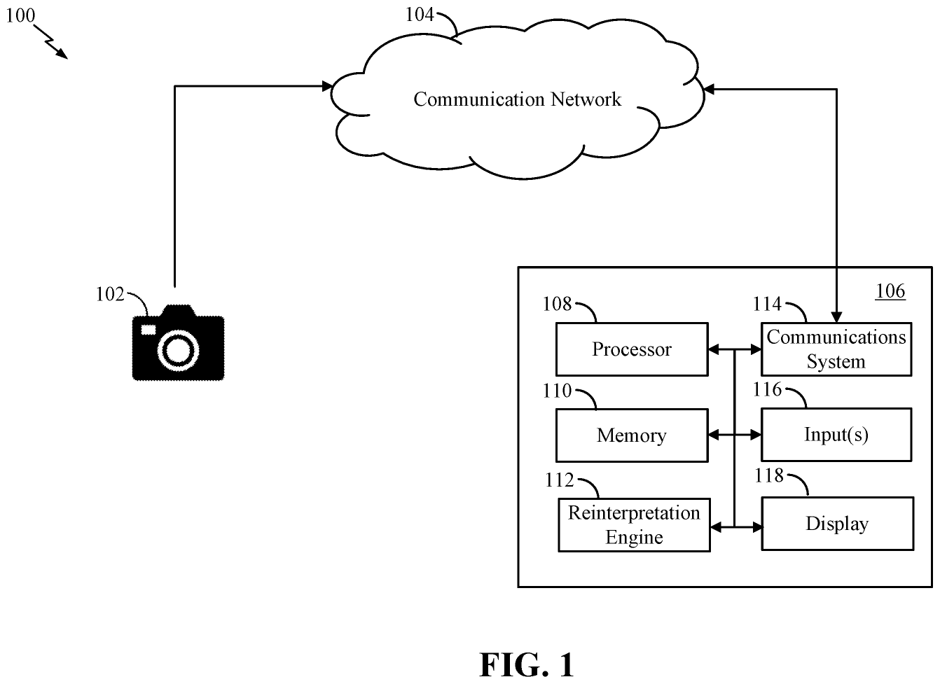

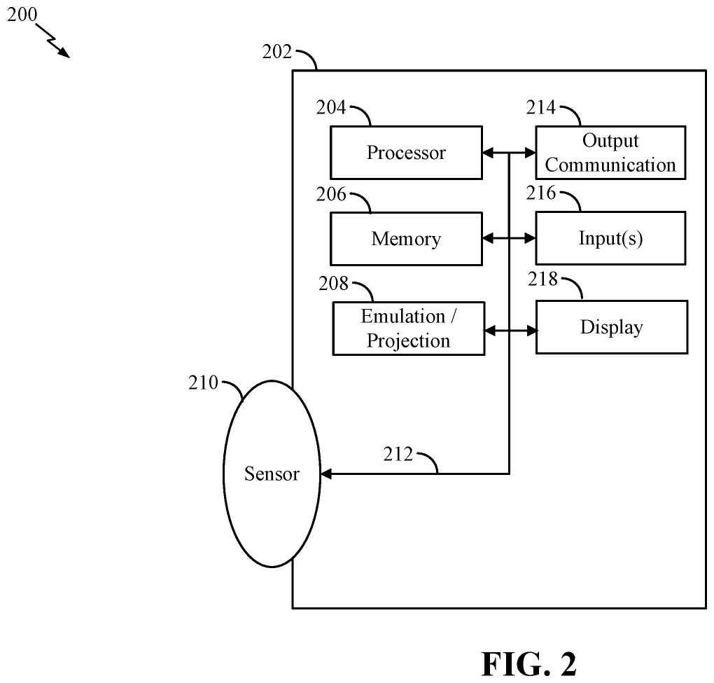

Certain techniques and advantages described herein can be achieved via a variety of different hardware configurations. For example, software instructions that operate on frame, or frame-like data, from a sensor could operate on a processor of the same device as the sensor, a locally connected device, or a remote resource. Thus, FIGS. 1 and 2 below provide general examples of possible configurations of hardware implementing aspects of the disclosure.

FIG. 1 shows a block diagram illustrating an example of a system 100 for generating images of various image modalities, from a single image sensor device. In other words, the system 100 can substitute for the use of multiple different cameras or sensor modalities, while still providing the capability of achieving imaging as though there were multiple different modalities.

In some examples, a computing device 106 can obtain frame data from a sensor 102 (such as a camera) or other connected device via a communication network 104. In some examples, a frame (e.g., the first frame, the second frame, etc.) of frame data 102 can include an image, a video frame, a single photon avalanche diode (SPAD) bit plane, an event frame, a depth map (with/without an image), a point cloud, or any other suitable frame data or frame-like data (for case of reference, the term “frame data” will in some instances be used to refer to all of such data types).

As depicted, the sensor 102 comprises a camera. As will be understood from the description herein, the sensor 102 may be a standalone sensor, or may be a variety of types of cameras. For example, sensor 102 may be a SPAD sensor of a SPAD camera or may be a high-frame-rate optical/CMOS camera.

In some embodiments described herein, reference will be made to “photon data” and “SPAD sensors” for purposes of illustration. Sensors based on single photon avalanche diodes (SPADs) allow for extremely high frame rate detection. This attribute makes it possible to utilize SPAD sensors/cameras to emulate a wide range of imaging modalities such as exposure bracketing, video compressive systems, and event cameras. SPAD arrays can operate as extremely high frame-rate photon detectors (e.g., ˜100 kHz or more), producing a temporal sequence of binary frames called a photon-cube. However, one of skill in the art will appreciate that alternative camera/sensor modalities exist that can also capture extremely high frame rates, such as multiple 1000s, tens of thousands, hundreds of thousands, or even millions of frames per second or more. The frame data captured by these cameras may be optical data, photon data, point clouds, depth data, or the like. The massive amounts of frame data offered by such sensors/cameras improve the ability of the techniques described herein to generate images that appear as though they were captured by a different camera/sensor (e.g., a capture by a SPAD sensor can be used to generate an image that appears as though it was captured by a different type/modality of sensor, such as an event camera).

The computing device 106 can include a processor 108. In some embodiments, the processor 108 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), cloud resource, etc.

The computing device 106 can further include, or be connected to, a memory 110. The memory 110 can include or comprise any suitable storage device(s) that can be used to store suitable data (e.g., frame data, an image rendering model, etc.) and instructions that can be used, for example, by the processor 108. The memory may be a memory that is “onboard” the same device as the sensor that detects the frames, or may be a memory of a separate device connected to the computing device 106. Methods for reinterpreting frame data of sensor 102 into an image of a different modality may operate as its independent processes/modules, such as a separate reinterpretation engine 112 that runs on the same processor 108 or a specialty processor (such as a GPU) that achieves greater efficiency in processing the frame data through projection operations, as described below. The memory 110 can include any suitable volatile memory, non-volatile memory, storage, or any suitable combination thereof. For example, memory 110 can include random access memory (RAM), read-only memory (ROM), electronically erasable programmable read-only memory (EEPROM), one or more flash drives, one or more hard disks, one or more solid state drives, one or more optical drives, etc.

In further examples, computing device 106 can receive or transmit information (e.g., receiving frame data from sensor 102, transmitting instructions to sensor 102, or transmitting images or image data to remote devices, etc.) and/or any other suitable system over a communication network 104. In some examples, the communication network 104 can be any suitable communication network or combination of communication networks. For example, the communication network 104 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In one embodiment, communication network 104 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In further examples, computing device 106 can further include a display 118 and/or one or more inputs 116. In one embodiment, the display 118 can include any suitable display devices, such as a computer monitor, a touchscreen, a television, an infotainment screen, etc. to display the report. In further embodiments, and/or the input(s) 116 can include any suitable input devices (e.g., a keyboard, a mouse, a touchscreen, a microphone, etc.). In yet further embodiments, the sensor 102 may be a camera that exports frame data to a remote resource 106, then receives emulated images from the resource 106 and displays them on a display 118 of the camera itself. In such an instance the display 118 and inputs 116 may be part of the camera 102.

Referring now to FIG. 2, an example of an alternative configuration is shown, in which the processor that generates emulated images is located in the same device as the sensor that captures the frame data. FIG. 2 shows a block diagram illustrating an example 200 of systems/devices for image emulation by a so-called “software-defined camera” method. The integrated device 202 thus includes a processor 108 that is a part of the device. As discussed above, the processor 108 can be any suitable hardware processor or combination of processors. The integrated device 202 can further include a memory 110. The memory 206 can include any suitable storage device(s) that can be used to store suitable data (e.g., frame data 210, a machine learning model, etc.) and instructions that can be used, for example, by the processor 204. In FIG. 2, the memory may be a memory that is “onboard” the same device as the sensor that detects the frame data. The memory 206 can include any suitable volatile memory, non-volatile memory, storage, or any suitable combination thereof, as described above. The memory and the processor may be connected via an internal bus or similar connection 212 that allows for processing of frame data without having to format the data for off-device transfer, which can be relatively slow compared to the frame rate of high-frame-rate cameras such as SPAD-based cameras.

In further examples, the integrated device 202 can further include a display 218 and/or one or more inputs 216. The display 218 can include any suitable display devices, such as a small LCD or LED screen, a touchscreen, or separate display screen connected to the camera. The input(s) 216 of the device can include any suitable input devices (e.g., buttons, switches, a touchscreen, a microphone, etc.).

### Methods and Techniques

As described herein, as frame data is captured by a given class/modality of sensor (e.g., single photon detectors, called single photon avalanche diodes (SPADs)), it is now possible to emulate a wide range of imaging modalities such as exposure bracketing, video compressive systems, motion cameras and event cameras. A user has the flexibility to choose one (or multiple) of these functionalities, whether as a setting made prior to image capture or even post-capture. In the following discussion, several example processes and techniques will be discussed that will modify or reinterpret frame data from one type of camera or sensor, such as high-frame-rate captures, in order to generate images that emulate an image taken from a different type or modality of camera/sensor. One step in some of these processes is referred to as a “projection,” in which certain modifications are made to frame data to allow them to be used to generate different image modalities. A projection can include various types of shifting, summing, and masking operations (and combinations thereof) performed on all or groups of discrete data frames (such as temporally sequential frames of a high-speed acquisition), as further described below.

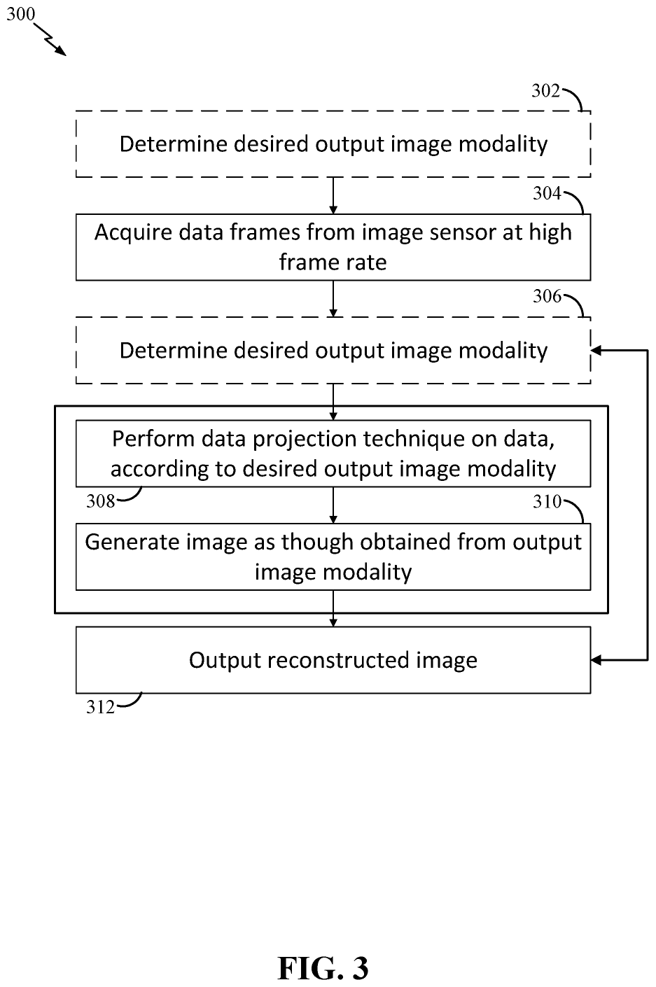

FIG. 3 is a flow diagram illustrating an example process 300 for generating emulated images (e.g., images reflecting a camera or sensor modality other than that of the actual camera or sensor that acquired the data from which the emulated images where made), in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., devices 106 or 202, processor 108 or 204 with memory 110 or 206, etc.) in connection with FIG. 1 or FIG. 2, respectively, can be used to perform all or part of example process 300. However, it should be appreciated that other suitable processing hardware for carrying out the operations or features described below may perform process 300.

At step 302, the process 300 optionally determines a desired output image modality. For example, a user may select a given type of image that corresponds to a particular camera/sensor modality, such as: an event camera, a motion/moving camera, a video compressive sensing camera, a spike camera, an ATIS event camera, a conventional optical camera, burst optical camera, or the like. In other embodiments, a device may have a default setting that determines the image modality that will be generated.

At step 304, the process 300 acquires data frames from an image sensor. For example, a camera or image sensor 102 or 210 may acquire data frames at a high frame rate. If not determined at step 302, the process 300 optionally determines a desired output image modality at step 306. In other words, after capture of the data frames, a user may be permitted to select an image modality that is the same as or different than the modality of the camera or image sensor 102 or 210. This can be done via a user interface, such as a display screen of a computing resource controlling process 300, via buttons or other inputs of a camera, or other suitable means.

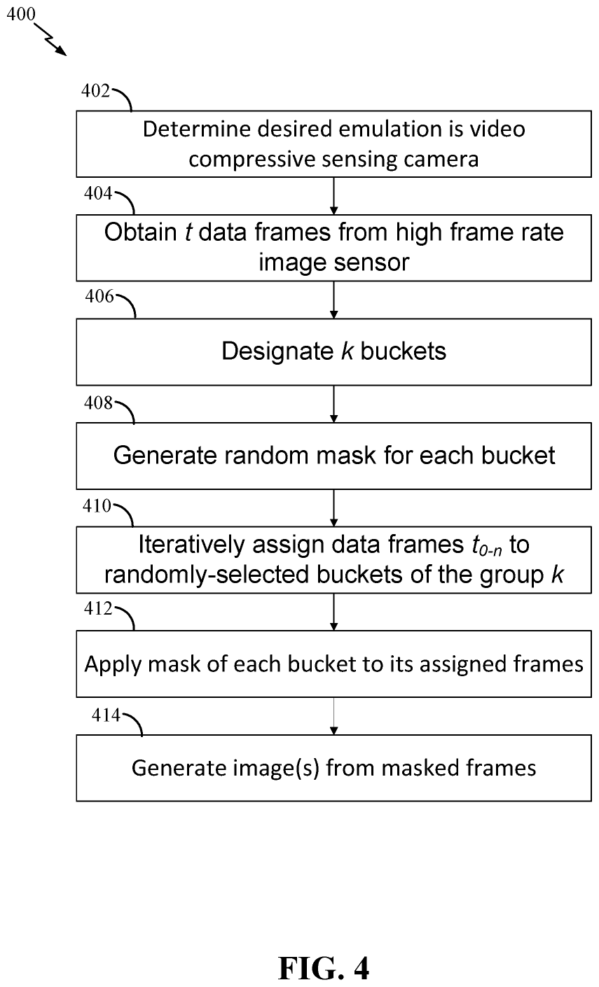

At step 308 a data projection technique is performed on the data according to the desired output image modality. For example, a projection technique as set forth in the example processes of FIGS. 4-6 may be employed.

At step 310, an image is generated from the frame data after the projection operation has been performed. In other words, the projection operation is performed to transform the frame data into data that can be reconstructed as a new type of image other than the type that would natively or customarily be produced by the camera or sensor that originally acquired the frame data.

Finally, at step 312, the process 300 outputs an emulated image, according to the desired imaging modality.

FIG. 4 is a flow diagram illustrating an example process 400 for generating video compressive sensing-emulated images in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., devices 106 or 202, processor 108 or 204 with memory 110 or 206, etc.) in connection with FIG. 1 or FIG. 2, respectively, can be used to perform example process 400. However, it should be appreciated that other suitable processing hardware for conducting the operations or features described below may perform process 400.

At step 402, the process 400 determines that the desired emulation to be generated is that of a video compressive sensing camera. For example, a user may choose this image modality, as described above.

At step 404, the process 400 obtains t data frames from the high frame rate image sensor. In some embodiments, the number of data frames may be a function of exposure time and frame rate of the camera. In other embodiments, the type of image to be generated may dictate that only a subset of the captured data frames used.

At step 406, the process 400 designates k buckets. The value of k may be 1, 2, 4, or other suitable numbers. As described in the examples sections below, each bucket serves to impose a mask, such as a binary mask, to compress data in the data frames. Thus, at step 408, the process 400 generates a random mask for each “bucket.”

At step 410, the process 400 iteratively assigns each of the data frames t₀₋ₙ to a randomly selected bucket of the group k. At step 412, the process 400 applies the mask of each bucket to its assigned frames. For example, all frames assigned to a given bucket are modified to “mask” data in a given position within the data frame (e.g., given pixels). At step 414, the process 400 generates images from the masked frames, as a typical compressive sensing image generation technique.

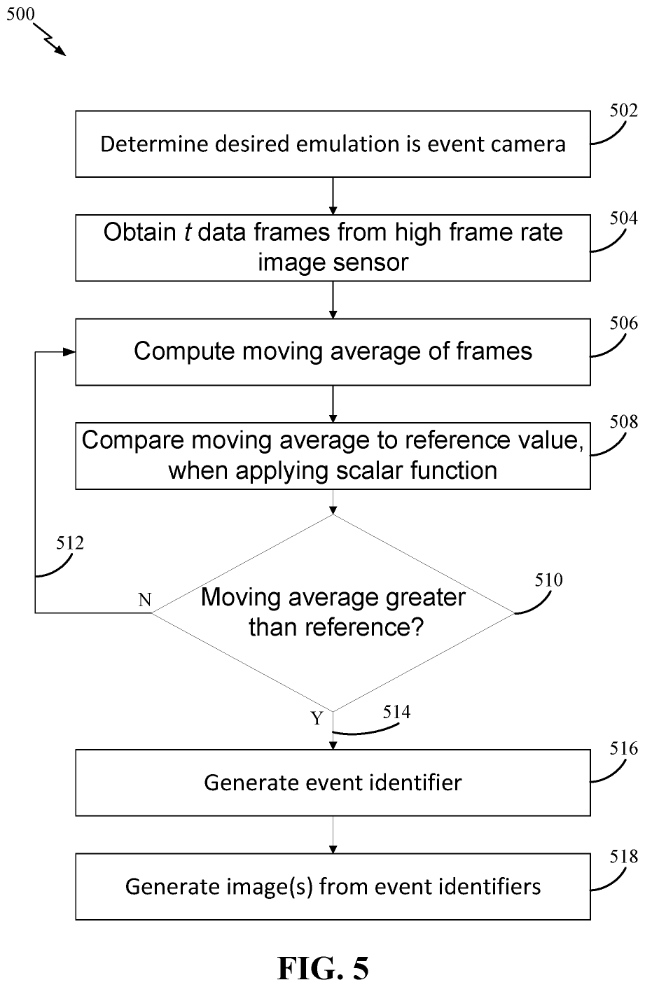

FIG. 5 is a flow diagram illustrating an example process 500 for generating images that emulate images captured by event cameras, in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., devices 106 or 202, processor 108 or 204 with memory 110 or 206, etc.) in connection with FIG. 1 or FIG. 2, respectively, can be used to perform example process 500. However, it should be appreciated that other suitable processing hardware for conducting the operations or features described below may perform process 500.

At step 502, the process 500 determines that the desired image modality of the image to be generated is that of an event camera. At step 504, the process 500 obtains 1 data frames from a high frame rate image sensor. These steps may be performed as described above.

At step 506, the process 500 computes the moving average of frames of the frame data. As described below in the examples sections, a moving average value of a given number of frames is computed. This may be done for an entire frame, or on a pixel-wise basis. The number of frames to be used in computing the average may be determined by a user or may be a function of the frame rate and data sparsity of the incoming frame data such that enough frames are grouped to provide meaningful averages. For SPAD-based cameras, the value may simply be the incidence values of each pixel integrated over the group of frames for which the average is being calculated. For optical cameras, the value may include intensity values, RGB color values, or a combination thereof.

At step 508, the computed moving average is compared to a reference value, when applying a scalar function. In other words, a reference value is determined (which may be a predetermined value or may be a function of baseline values calculated for the scene at issue). The moving average value and reference value may be modified by a scalar function, for smoothing or taking into account attributes of the physical sensor involved. Examples of such scalar functions are described below in the examples section.

At step 510, the process 500 determines if the moving average is greater than the reference value. If the moving average is not greater than the reference value (512), the process iteratively continues measuring moving averages at step 506 along the time domain. If the moving average is greater than the reference values (514), the process continues to step 516. At step 516, an event identifier is generated. At step 518, images are generated from the event identifiers, per event camera image reconstruction techniques.

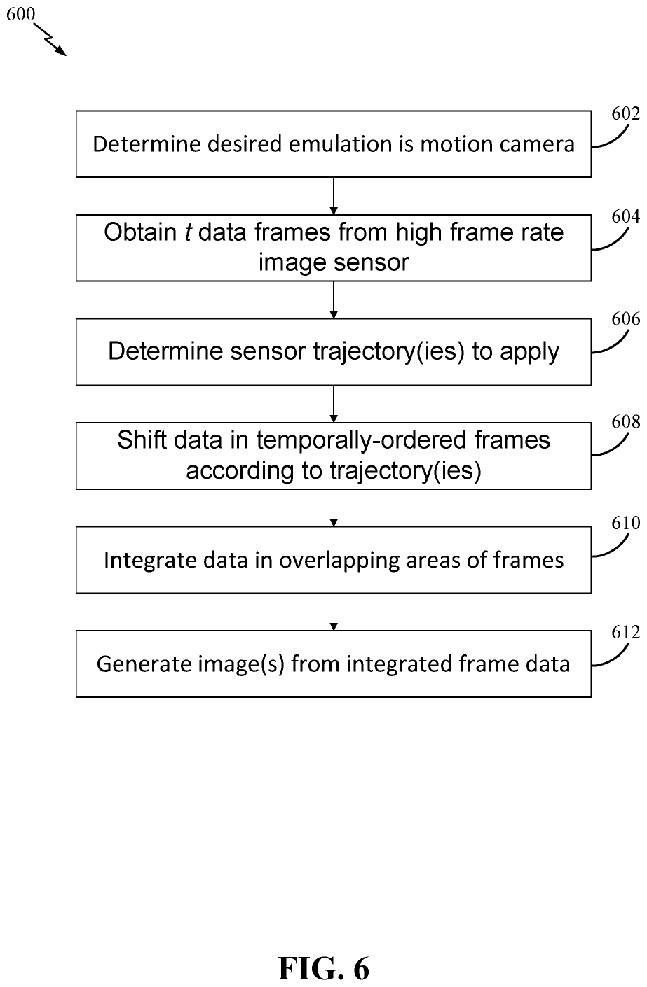

FIG. 6 is a flow diagram illustrating an example process 600 for generating images from integrated frame data in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., devices 106 or 202, processor 108 or 204 with memory 110 or 206, etc.) in connection with FIG. 1 or FIG. 2, respectively, can be used to perform example process 600. However, it should be appreciated that other suitable processing hardware for conducting the operations or features described below may perform process 600.

At step 602, process 600 determines that the desired image emulation modality is that of a motion camera. For example, a motion camera may include a camera designed to acquire video or images while in motion, such as via a dolly or other similar means. In other words, a “motion camera” may include a moving camera and/or cameras designed for acquisitions while in motion.

At step 604, t data frames are obtained from a high frame rate image sensor (e.g., that is not a motion camera). At step 606, the process 600 determines a sensor trajectory (or sensor trajectories) to apply. As described below in the examples section, the sensor trajectories may be linear (across any of the three dimensions of a data frame cube resulting from a high-frame-rate exposure) in any direction, parabolic, a combination of the two, or a learned/acquired trajectory corresponding to actual motion of an object represented in the frame data.

At step 608, the data frames are “shifted” in a spatio-temporal fashion according to the trajectory (or trajectories). For example, sequential data planes of a SPAD sensor may be shifted according to a discretized trajectory r, such that each plane is moved relative to the preceding plane in an x,y manner. At step 610, the data is integrated in overlapping areas of frames. In other words, only those portions of the shifted frames that still “overlap” the other frames (in the temporal direction of the data frame cube) are integrated. At step 612, images are generated from the integrated frame data.

### Example Embodiments and Experimental Findings

As case studies, the inventors emulated three distinct imagers: high-speed video compressive imaging; event cameras which respond to dynamic scene content; and motion projections which emulate sensor motion, without any real camera movement. However, it is to be recognized that additional imaging modalities are described herein and within the scope of this disclosure. Furthermore, the data presented below was generated from a SPAD camera, but it is to be understood that these examples should apply equally to other similar camera modalities capable of high-frame-rate acquisition.

### Computing Photo-Cube Projections

One way to obtain photon-cube projections is to read the entire photon-cube off the SPAD array and then perform computations off-chip. This strategy is adopted for the experiments described herein. Reading out photon-cubes requires an exorbitant data-bandwidth—up to 100 Gbps for a 1 MPixel array—that will further increase as large-format SPAD arrays are fabricated.

An alternative is to avoid transferring the entire photon-cube by computing projections near sensor. As a proof-of-concept, photon-cube projections on UltraPhase, a programmable SPAD imager with independent processing cores that have dedicated RAM and instruction memory has been implemented. Computing projections on-chip reduces sensor readout and power consumption is shown herein.

### Implications: Toward a Photon-Level Software-Define Camera

The photon-cube projections introduced herein are computational constructs that provide a realization of software-defined cameras or SoDaCam. Being software-defined, SoDaCam can emulate multiple cameras simultaneously without additional hardware complexity. SoDaCam, by going beyond baked in hardware choices, unlocks hitherto unseen capabilities-such as 2000 FPS video from 25 Hz readout; event imaging in very low-light conditions; and motion stacks, which are a stack of images where in each image, objects only in certain velocity ranges appear sharp.

Consider a SPAD array observing a scene. The arrival of photons at a pixel during exposure time tₑₓₚ can be modelled as a Poisson process:

$$P r \{ N = k \} = \frac{{( η Φ ( ) {t}_{exp} )}^{k} {e}^{- η Φ ( ) {t}_{exp}}}{k !} , \qquad ( 1 )$$

where N is the number of photon arrivals, Φ(x) is the mean incident flux (number of photons per unit time), and n is the quantum efficiency of the SPAD sensor. During each exposure, a pixel detects at most one photon, returning a binary value B(x) such that B(x)=0 if the pixel receives no photons; otherwise, B(x)=1. Hence, B(x) is a Bernoulli random variable with

$$P r \{ B ( x ) = 1 \} = 1 - {e}^{- ( η Φ ( x ) + {r}_{q} ) {t}_{exp} ,} \qquad ( 2 )$$

where r_{q} is the dark count rate—the rate of spurious counts unrelated to incident photons. Suppose the SPAD captures a photon-cube comprising of T binary frames, {Bₜ(x)}_{1≤t≤T}. Then, the temporal sum

$${I}_{s u m} ( x ) := {\sum }_{t = 1}^{T} {B}_{t} ( x ) , \qquad ( 3 )$$

yields a maximum likelihood estimate (MLE) of Φ(x), given by \hat{Φ}(x)=−log (1−ₛᵤₘ (x)/T)/ηtₑₓₚ−r_{q}/tₑₓₚ.

### Projection of the Photon-Cube

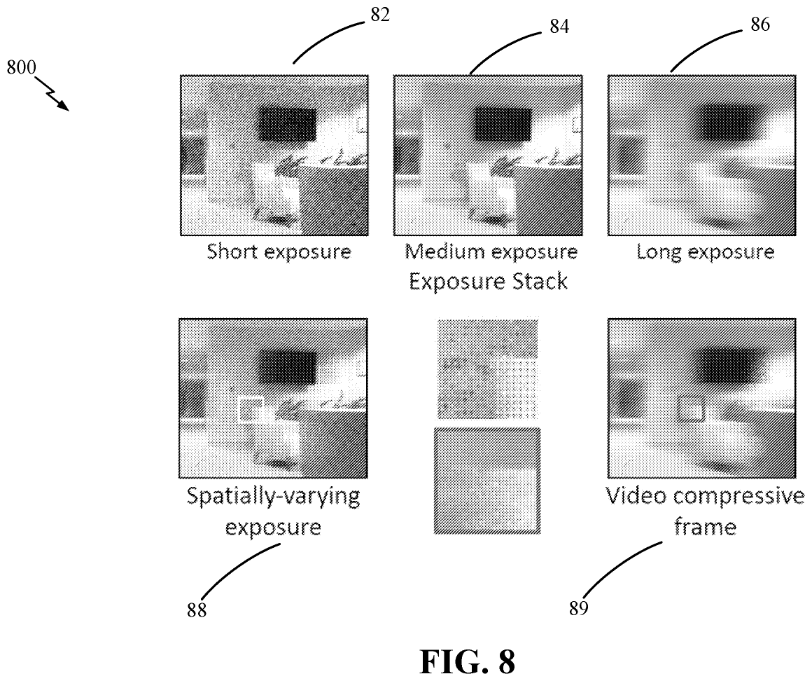

The temporal sum described in Eq. (3) is a simple instance of projections of a photon-cube. One observation is that it is possible to compute a wide range of photon-cube projections, each of which emulates a unique sensing modality post-capture—including modalities that are difficult to achieve with conventional cameras. For example, varying the number of bit-planes that are summed over emulates exposure bracketing, which is typically used for HDR imaging. Compared to conventional exposure bracketing, the emulated exposure stack, being software-defined, does not require spatial and temporal registration, which can often be error-prone. Panels 82-86 in FIG. 8 show an example of an exposure stack (short, medium, and long exposures) computed from a photon-cube.

Going further, the complexity of the projections can be gradually increased. For example, consider a coded exposure projection that multiplexes bit-planes with a temporal code:

$${I}_{flutter} ( x ) := {\sum }_{t = 1}^{T} {C}_{t} {B}_{t} ( x ) , \qquad ( 1 )$$

where Cₜ is the temporal code. An example of globally-coded exposures is the flutter shutter camera, which uses pseudo-random binary codes for motion-deblurring.

More general coded exposures can be obtained via spatially-varying temporal coding patterns Cₜ (x):

$${I}_{coded} ( x ) := {\sum }_{t = 1}^{T} {C}_{t} ( x ) {B}_{t} ( x ) . \qquad ( 2 )$$

Panel 88 in FIG. 8 shows an example of spatially-varying exposures that use a quad (Bayer-like) spatial pattern and random binary masks. With photon-cubes, spatially-varying coding can be performed without bulky spatial light modulators, similar to focal-plane sensor-processors. Moreover, multiple coded exposures can be simultaneously captured, which is challenging to realize in existing sensors. Coding patterns for video compressive sensing is described herein as well, such as illustrated in panel 89 of FIG. 8.

Spatial and temporal gradients form the building blocks of several computer vision algorithms. Given this, another projection of interest is temporal contrast, i.e., a derivative filter preceded by a smoothing filter:

$${I}_{contrast} ( x , t ) := {D}_{t} ∘ G * {B}_{t} ( x ) , \qquad ( 3 )$$

where Dₜ is the difference operator, G could be exponential or Gaussian smoothing, and * denotes convolution. Due to their sparse nature, gradients form the basis of bandwidth- and power-efficient neuromorphic sensors such as event cameras.

A more general class of spatio-temporal projections that lead to novel functionalities can be considered. For instance, computing a simple projection, such as the temporal sum, along arbitrary spatio-temporal directions emulates sensor motion during exposure time, but without moving the sensor. This can be achieved by shifting bit-planes and computing their sum:

$${I}_{shift} ( x ) := {\sum }_{t = 1}^{T} {B}_{t} ( x + r ( t ) ) , \qquad ( 4 )$$

where r is a discretized 2D trajectory that determines sensor motion. Outside a software-defined framework, such projections are hard to realize without physical actuators. Described herein are the capabilities of motion projections.

In summary, embodiments of systems and methods that leverage photon-cube projections can be thought of as simple linear and shift operators that lead to a diverse set of post-capture imaging functionalities. These projections pave the way for future ‘swiss-army-knife’ imaging systems that achieve multiple functionalities (e.g., event cameras, high-speed cameras, conventional cameras, HDR cameras) simultaneously with a single sensor. Finally, these projections can be computed efficiently in an online manner, which makes on-chip implementation viable.

The extremely high temporal-sampling rate of SPADs and similar detectors makes them suitable for performing the types of photon cube projections described herein. The temporal sampling rate allows for one or more aspects of sensor emulation, such as the discretization of temporal derivatives and motion trajectories.

### Trade-Off Between Frame Rate and SNR

In principle, photon-cube projections can be computed using regular (CMOS or CCD based) high-speed cameras. Unfortunately, each frame captured by a high-speed camera incurs a read-noise penalty, which increases with the camera's framerate. The read noise levels of high-speed cameras can be 10-30× higher than consumer cameras. Coupled with the low per-frame incident flux at high framerates, prominent levels of read noise result in extremely low SNRs. In contrast, SPADs do not incur a per-frame read noise and are limited only by the fundamental photon noise. Hence, to perform the post-capture software-defined functionalities proposed here, SPADs may be used.

Emulating Cameras from Photon-Cubes

The concept of photon-cube projections, and its potential for achieving multiple post-capture imaging functionalities are presented herein. As case studies, three imaging modalities are demonstrated: video compressive sensing, event cameras, and motion-projection cameras. These modalities have been well-studied over several years; in particular, there exist active research communities around video compressive sensing and event cameras today. New variants of these imaging systems that arise from the software-defined nature of photon-cube projections are also shown.

### Video Compressive Sensing

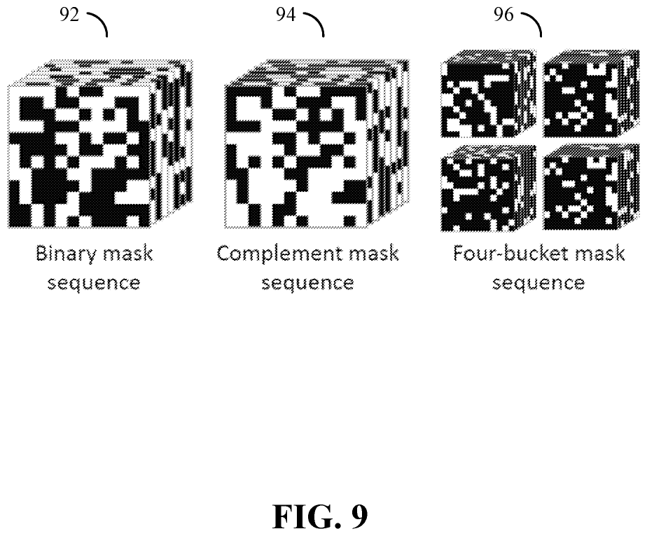

Video compressive systems optically multiplex light with random binary masks, such as the patterns 92 in FIG. 9. As discussed in the previous section, such multiplexing can be achieved computationally using photon-cubes.

### Two-Bucket Cameras

One drawback of previous approaches for capturing coded measurements is the light loss due to blocking of incident light. To prevent loss of light, coded two-bucket cameras capture an additional measurement that is modulated by the complementary mask sequence (FIG. 9, 94). Such measurements recover higher quality frames, even after accounting for the extra readout. However, as described herein, two-bucket captures can be readily derived from photon-cubes, through a projection method that implements eq: video-comp with the additional mask sequence.

### Multi-Bucket Camera

The idea of two-bucket captures to multi-bucket captures can be extended by accumulating bit-planes in one of k buckets that is randomly chosen at each time instant and pixel location. Since multiplexing is performed computationally, no losses in photoreceptive area that hampers existing multi-bucket sensors are faced. Multi-bucket captures can reconstruct a large number of frames by better conditioning video recovery and provide extreme high-speed video imaging. Item 96 in FIG. 9 shows the modulating masks for a four-bucket capture.

### Event Cameras

Next, the emulation of event-cameras is described, which capture changes in light intensity and are conceptually similar to the temporal contrast projection introduced in Eq. 6. Physical implementations of event sensors generate a photoreceptor voltage V(x,t) with a logarithmic response to incident flux Φ(x,t), and output an event (x,t,p) when this voltage deviates sufficiently from a reference voltage V_{ref}(x):

$$\vert V ( x , t ) - {V}_{ref} ( x ) \vert > τ , \qquad ( 1 )$$

where τ is called the contrast-threshold and p=sign (V(x,t)−V_{ref}(x)) encodes the polarity of the event. Once an event is generated, V_{ref}(x) is updated to V(x,t). Eq. 8, for a smoothly-varying flux intensity, thresholds a function of the temporal gradient, i.e., ∂ₜ log(Φ(x,t)).

To produce events from SPAD frames, an exponential moving average (EMA) of the bit-planes is computed, as μₜ(x)=(1−B)Bₜ (x)+βμₜ₋₁ (x)—where μₜ(x) is the EMA, β is the smoothing factor, and Bₜ is a bit-plane. An event when μₜ(x) deviates from μ_{ref} (x) by at least τ is generated:

$$\vert h ( {μ}_{t} ( x ) ) - h ( {μ}_{ref} ( x ) ) \vert > τ , \qquad ( 2 )$$

where h is a scalar function applied to the EMA. Eq. 9 thresholds temporal contrast, by observing the role played by the EMA and the difference operator.

Setting h to be the logarithm of the flux MLE mimics Eq. 8. However, since the log-scale is used to prevent sensor saturation, a simpler alternative is to use the non-saturating response curve of SPAD pixels (h(x)=x). The response curve takes the form of 1−exp(−αΦ(,t)), where α is a flux-independent constant. Accordingly, this response curve avoids the underflow issues of the log function that can occur in low-light scenarios.

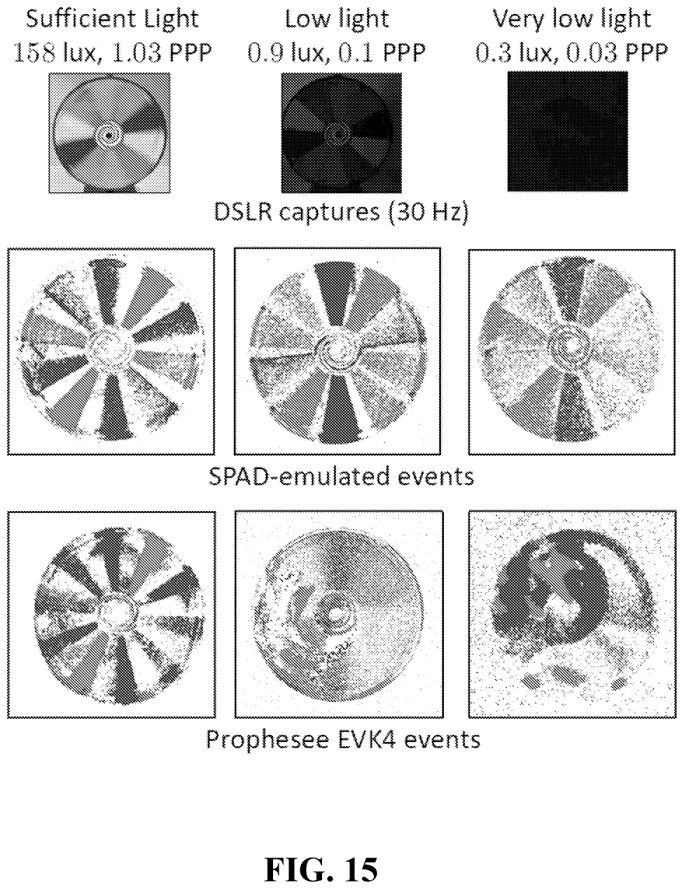

FIG. 15 illustrates a comparison of brightness encoding functions, according to some example methods provided herein. While the log-MLE is comparable to using the SPAD's response curve at ambient light levels, at low flux levels the underflow issues associated with the log function occur. In FIG. 15, a denotes a sensor-determined and flux-independent constant.

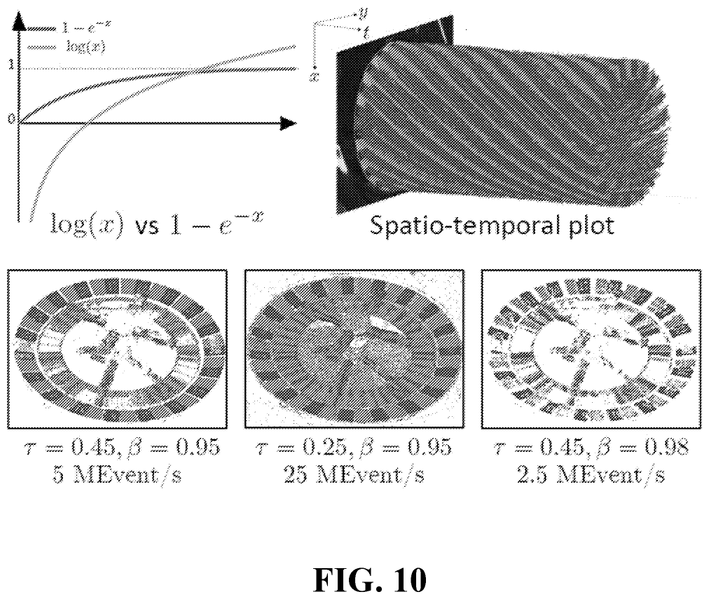

The SPAD's frame-rate determines the time-stamp resolution of emulated events. In FIG. 10, the events generated from a photon-cube acquired at a frame-rate of 96.8 kHz are shown—resulting in a time-stamp resolution of 10 us that is comparable to those of existing event cameras.

A difference between an ‘event’ captured via the projection methods described herein (e.g., via a SPAD sensor) versions a traditional event camera, is the expression of temporal contrast, given by ∂ₜh, is now −∂ₜ exp (−αΦ(x,t), instead of ∂ₜ log(Φ(x,t). This difference poses no compatibility issues for a large class of event-vision algorithms that utilize a grid of events or brightness changes. Finally, SPAD-events can be easily augmented with spatially- and temporally-aligned intensity information—a synergistic combination that has been exploited by several recent event-vision works.

### Motion Projections

Two useful trajectories when emulating motion cameras are described herein using Eq. 7.

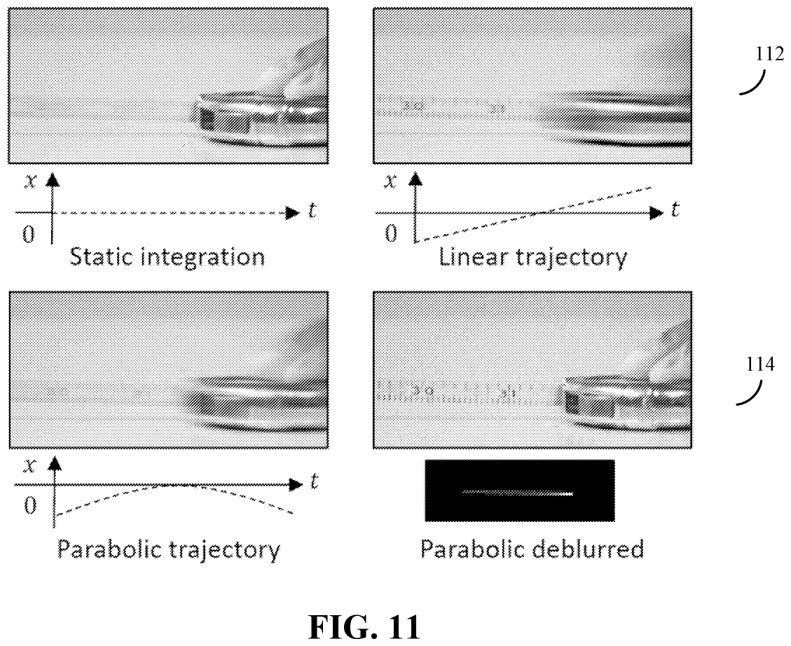

The simplest sensor trajectory involves linear motion, with the parameterization r(t)=(bt+c) p for some constants b, c E R and unit vector p. As the set of panels 112 in FIG. 11 shows, this can change the scene's frame of reference: making moving objects appear stationary and vice-versa.

If motion is along p, parabolic integration produces a motion-invariant image-all objects, irrespective of their velocity, are blurred by the same point spread function (PSF), upto a linear shift. Thus, a deblurred parabolic capture produces a sharp image of all velocity groups (FIG. 11, 114). The parabolic trajectory is given by r(t)=(αt²+bt+c) p. α was chosen based on the maximum object velocity and b, c so the parabola's vertex lies at T/2. The PSF was readily obtained by applying the parabolic integration to a delta input.

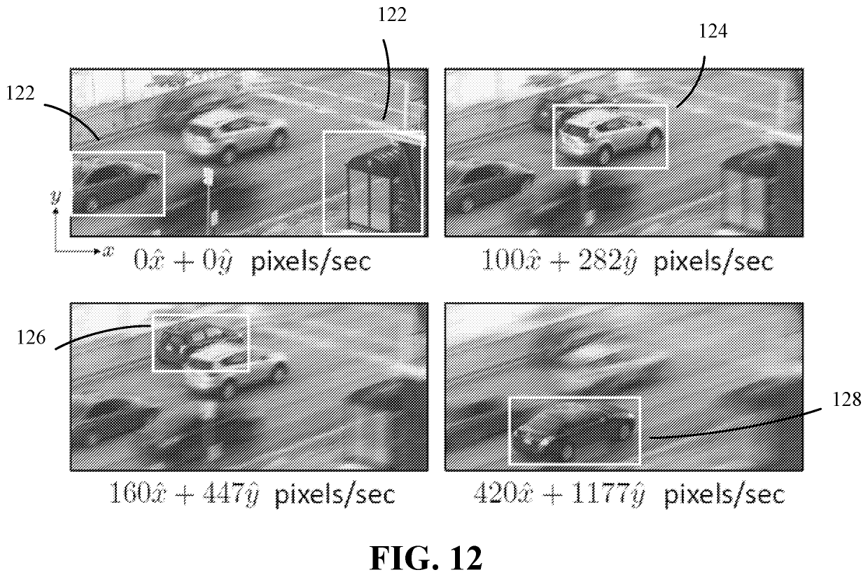

Additionally, the flexibility of photon-cubes 122 is leveraged to compute multiple linear projections, as seen in FIG. 12. This produces a stack of images where one velocity group 122, 124, 126, or 128, is motion-blur free at a time—or a ‘motion stack’, analogous to a focal stack. This novel construct can be used to compensate motion by blending stack images using cues such as blur orientation or optical flow.

### Hardware and Experimental Results

A range of experiments was designed to demonstrate the versatility of photon-cube projections: both when computations occur after readout, and when they are performed near-sensor on-chip. All photon-cubes were acquired using a 512×256 SwissSPAD2 array, operated at a frame-rate of 96.8 kHz. For the on-chip experiments, the UltraPhase compute architecture was used to interface with photon-cubes from the SwissSPAD2.

### High-Speed Compressive Imaging

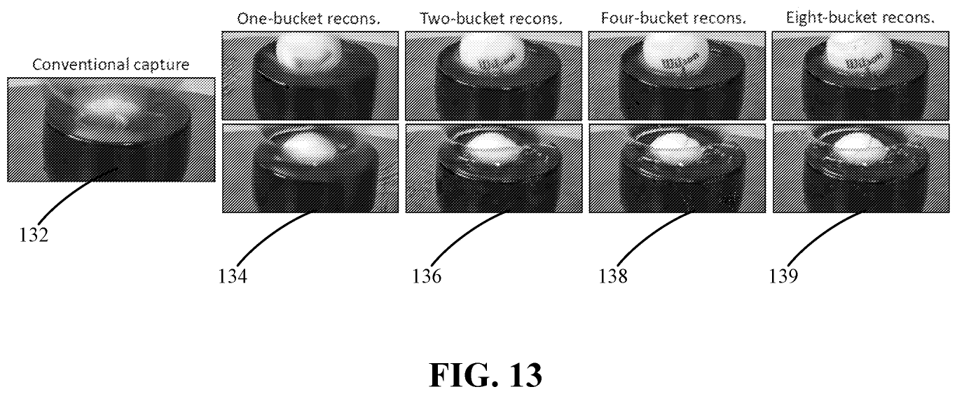

In one experiment, a set of 80 frames was constructed from compressive snapshots that are emulated at 25 Hz, resulting in a 2000 FPS video. Compressive snapshots were decoded using a plug-and-play (PnP) approach, PnP-FastDVDNet. As FIG. 13 shows, it is challenging to recover a large number of frames from a single compressive measurement 132. Using the proposed multi-bucket scheme (whether one 134, two 136, four 138, or eight 139 buckets) significantly improves the quality of video reconstruction.

### Motion Projections on a Traffic Scene

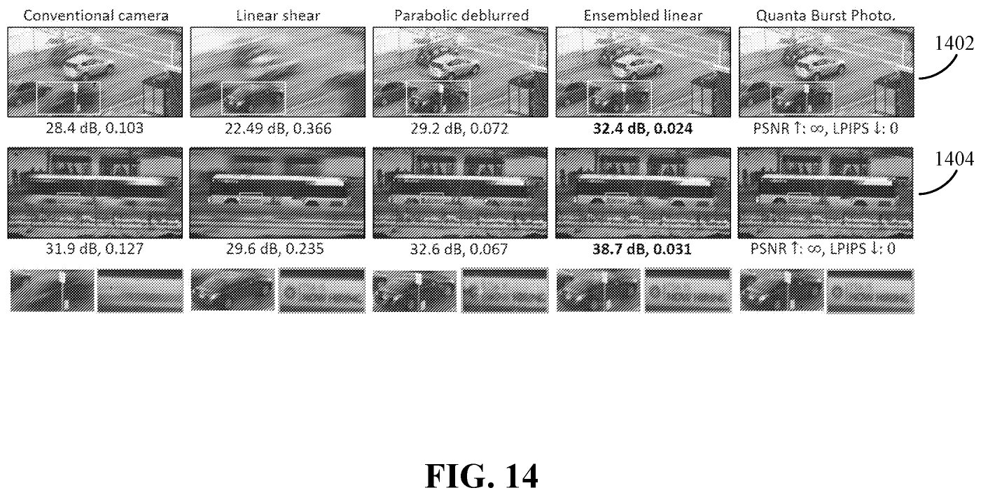

FIG. 14 shows two traffic scenes 1402 and 1404 captured using a 50 mm focal length lens and at 30 Hz emulation. When object velocity is known, a linear projection can make moving objects appear stationary. If only the velocity direction is known (e.g., road's orientation in fig: motion-recons), a parabolic projection provides a sharp reconstruction of all objects. Parabolic captures are deblurred using PnP-DnCNN. An improvement is offered by randomly sampling 8 linear projections along the velocity direction and blending them using the optical flow predicted by RAFT between two short-exposures.

### Low-Light Event Imaging

FIG. 9 compares event-image visualizations of SPAD and that of a state-of-the-art commercial event sensor (Prophesee EVK4), across various light levels, with an accumulation period of 33 ms. For a fair comparison, the Prophesee's events in 2×2 blocks are binned and a smaller aperture is used to account for the lower fill-factor of the SPAD. Event-generation parameters of both cameras at each light level are tuned. Low light induces blur and deteriorates the Prophesee's event stream. In contrast, SPAD-events continue to capture temporal gradients, due to the SPAD's low-light capabilities and its brightness-encoding response curve.

The observations are in concurrence with recent works that examine the low-light performance of event cameras, and show that SPAD-events can provide neuromorphic vision in these challenging-SNR scenarios.

### Comparison to High-Speed Cameras

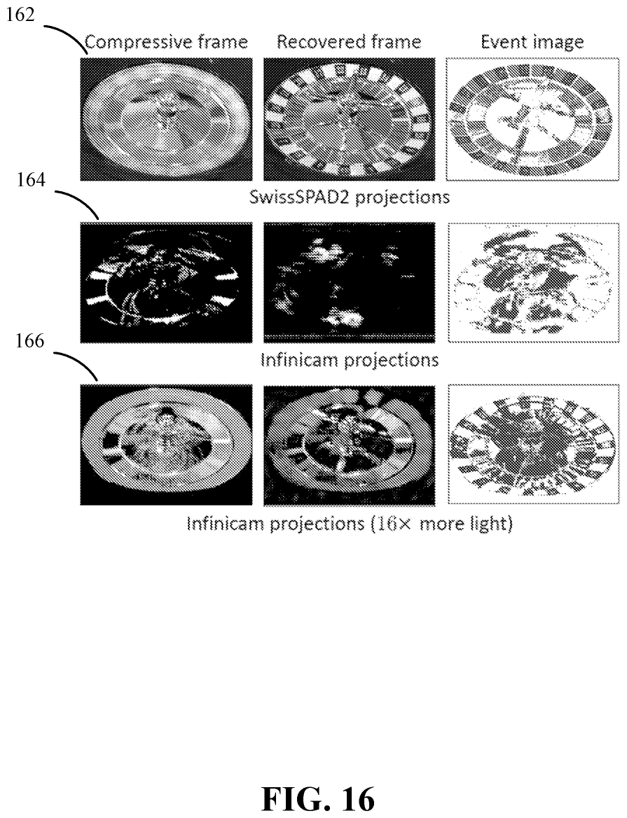

As previously discussed, read-noise can impact the per-frame SNR of high-speed cameras. To demonstrate this impact, projections were computed using the 4 kHz acquisition of the Photron Infinicam, a conventional high-speed camera, at a resolution of 1246× 240 pixels. The SwissSPAD2 162 and the Infinicam 164 is operated at ambient light conditions using the same lens specifications. As FIG. 16 shows, read noise corrupts the incident signal in Infinicam 164 and makes it impossible to derive any useful projections. The read noise could be averaged out to some extent if the Infinicam did not perform compression-on-the-fly, but compression is central to the camera's working and enables readout over USB. Using a larger aperture to admit more light 166 improves the quality of computed projections, but the video reconstruction and event image remain considerably worse than corresponding outputs of the SPAD.

### Bandwidth and Power Implication

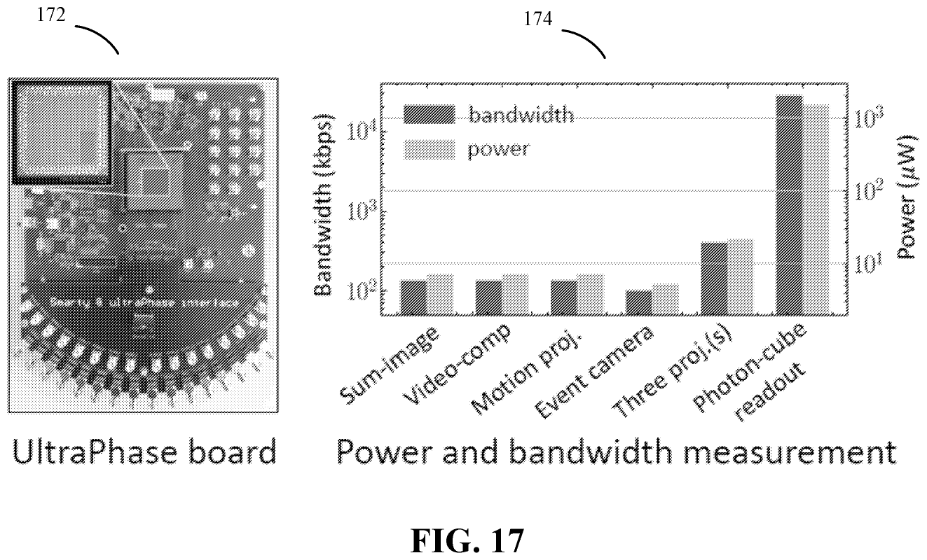

Projections can also be obtained in a bandwidth-efficient manner via near-sensor computations. Photon-cube projections are implemented on UltraPhase (FIG. 17, 172), a novel compute architecture designed for single-photon imaging. UltraPhase includes 3×6 processing cores, each of which interfaces with 4×4 pixels, and can be 3D stacked beneath a SPAD array.

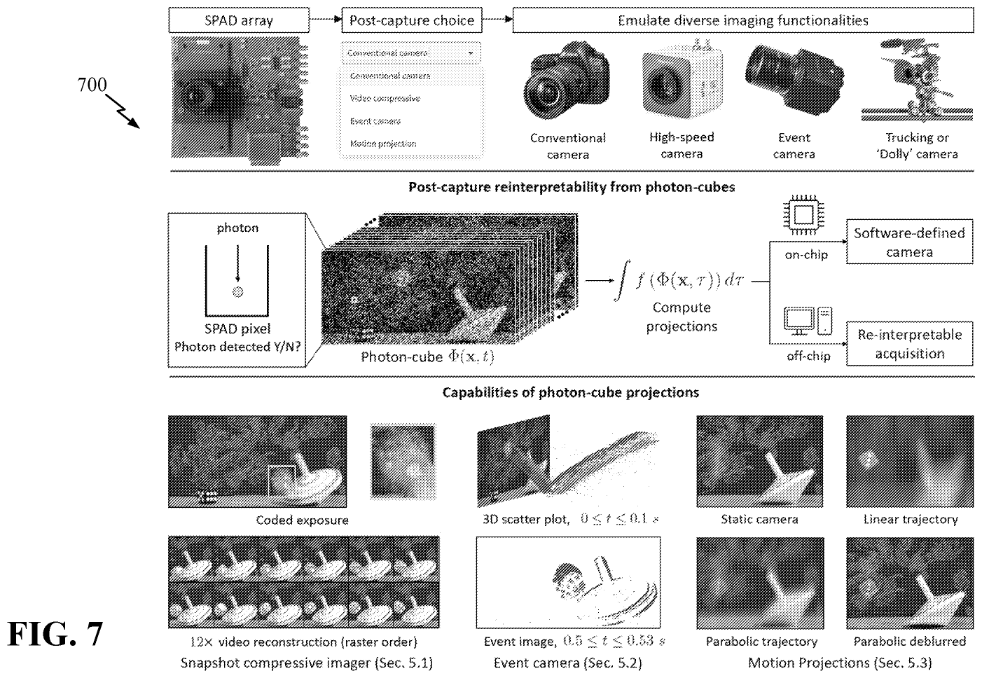

The readout and power consumption of UltraPhase is measured when computing projections on 2500 bit-planes of the falling die sequence (FIG. 7). The projections include: VCS with 16 random binary masks, an event camera, a linear projection and a combination of the three. Projections are outputted at 12-bit depth and calculate metrics based on the clock cycles used for both compute and readout. As seen in 174 of FIG. 17, computing projections on-chip dramatically reduces sensor-readout and power consumption as compared to reading out the photon-cube. Finally, similar to existing event cameras, SPAD-events have a resource footprint that reflects the underlying scene dynamics.

In summary, the on-chip experiments show that performing computations near-sensor can increase the viability of single-photon imaging in resource constrained settings. Thus, the inventors' work can be recognized as a solution that provides a realization of reinterpretable software-defined cameras at the fine temporal resolution of SPAD-acquired photon-cubes. The proposed computations, or photon-cube projections, can match and in some cases, surpass the capabilities of existing imaging systems. The software-defined nature of photon-cube projections provides functionalities that may be difficult to achieve in conventional sensors. These projections can reduce the readout and power-consumption of SPAD arrays and potentially spur widespread adoption of single-photon imaging in the consumer domain. Finally, future chip-to-chip communication standards may also make it feasible to compute projections on a camera image signal processor.

### A Platform for Comparing Cameras

Comparing imaging modalities can be difficult without ensuring that the sensor characteristics of their hardware realizations are similar, such as their quantum efficiency, pixel pitch and array resolution. By emulating their imaging models, SoDaCam can serve as a platform for hardware-agnostic comparisons.

Besides comparing cameras, being software-defined, SoDaCam can also make it significantly easier to develop new imaging models, and facilitate camera-in-the-loop optimization by tailoring photon-cube projections for downstream tasks. This is an exciting future line of research.

### Example Methods and Algorithms

The following describes several examples of methods and algorithms that can be used for emulation of various types of image modalities, as described above. Moreover, the following examples may specify algorithmic details or specific calculations/functions for achieving such emulations.

### Multi-Bucket Capture Algorithm

Algorithm 1 describes the emulation of J-bucket captures, denoted as I_{coded}^{j}(x) from the photon-cube Bₜ(x) using multiplexing codes Cₜ^{j} (x), where 1≤j≤J. Both single compressive snapshots (or one-bucket captures) and two-bucket captures can be emulated as special cases of Algorithm 1, with J=1 and J=2 respectively. In some examples, a system (such as a device falling within the disclosure of FIGS. 2 and 3) may capture frame data and perform an emulation process on the frame data using Algorithm 1.

Algorithm 1

```
Require: Photon-cube Bₜ(x)
  Number of buckets J
  Multiplexing code
  Multiplexing code for j^{th} bucket, 1 ≤ j ≤ J, Cₜ^{j}(x)
  Pixel locations X
  Total bit-plantes T
Ensure: Multiplexed captures I_{coded}^{j}(x)
  function MULTIBUCKETEMULATION (Bₜ(x), Cₜ^{j} (x))
    Y^{j}(x) ← 0, ∀ j
    for x ∈ X, 1 ≤ j ≤ J do
      I_{coded}^{j}(x) ← I_{coded}^{j}(x) + Bₜ(t) · Cₜ^{j}(x)
    end for
  end for
return I_{coded}^{j}(x)
end function
```

Mask sequences for video compressive sensing: For a single compressive capture (J=1), a sequence of binary random is used (i.e., Cₜ^{j} (x)=1 with probability 0.5. For a two bucket capture, Cₜ² (x)=1−Cₜ¹ (x) is used, which is the complementary mask sequence. For J>2, at each timestep t and pixel location x, the active bycket is chosen at random: Cₜ^{j} (x)←1, j˜Uniform (1,J). This is a direct generalization of the masking used for both one- and two-bucket captures.

### Event-Generation Algorithm

Algorithm 2 is an example algorithm for emulating events from photon-cubes. The contrast threshold t and exponential smoothing factoring β are the two parameters that determine the characteristics of the resulting event stream, such as its event rate (number of events per second). An initial time-interval T₀ (typically 80-100 bit-planes) was used to initialize the reference moving average, with T₀ being smaller than T. The result of this algorithm is an event-cube, Eₜ (x), which is a sparse spatio-temporal grib of event polarities—positive spikes are denoted by 1 and negative spikes by −1. From the emulated event-cube, other event representations can be computed such as: an event stream, {(x,t,p)}, where p∈{−1,1} indicates the polarity of the event; a frame of accumulated events; and a voxel grid representation, where events are binned into a few temporal bins. In some examples, a system (such as a device falling within the disclosure of FIGS. 2 and 3) may capture frame data and perform an emulation process on the frame data using Algorithm 2.

Algorithm 2

```
Require: Photon-sube Bₜ(x)
  Contrast threshold τ
  Exponential smoothing factor, β
  Pixel locations X
  Initial time-interval T₀, for computing refernce moving average
  Total bit-planes T
Ensure: Event-cube Eₜ(x) that describes the spatio-temporal spikes
  function EVENTCAMERAEMULATION (Bₜ(x), τ, β, T₀)
    Eₜ(x) ← 0, ∀t, ∀x
    for x ∈ X do
      Reference moving average, μ_{ref}(x)←0
      Current moving average, μ₀(x)←0
      for 1 ≤ t ≤ T₀ do
        μ_{ref}(x) ← βμ_{ref}(x) + (1 − β)Bₜ(x)
      end for
      for T₀ ≤ t ≤ T do
        μt(x) ← βμₜ₋₁(x) + (1 − β)Bt(x)
        if |μₜ(x) − μ_{ref}(x)| > τ then
          Eₜ(x) ← sign(μₜ(x) − μ_{ref}(x))
          μ_{ref}(x) ← μₜ(x)
        end if
      end for
    end for
  return Eₜ(x)
  end function
```

### Algorithm for Emulating Motion Cameras

Algorithm 3 provides example algorithm for emulating sensor motion from a photon-cube, where the sensor's trajectory is determined by the discretized function r. At each time instant t, the bit-planes are shifted by r(t) and accumulate d in I_{shift}. For pixels that are out-of-bounds, no accumulation is performed. For this reasons, the number of summations that occur vary spatially across pixel locations x. The emulated shift-image is normalized by the number of pixel-wise accumulations N(x) to account for this. The function r can be obtained by discretizing any smooth 2D trajectory: by either rounding up or dithering, or by using a discrete line-drawings algorithm. In some examples, a system (such as a device falling within the disclosure of FIGS. 2 and 3) may capture frame data and perform an emulation process on the frame data using Algorithm 3.

Algorithm 3

```
Require: Photon-cube Bₜ(x)
  Discretized trajectory r(t)
  Pixel location X
  Total bit-planes T
Ensure: I_{shift}(x)
  function MOTION CAMERAEMULATION (Bₜ(x), r)
  I_{shift}(x) ← 0, ∀x
  for x ∈ X do
    Normalizer, N(x) ← 0
    for 1 ≤ t ≤ T do
      if x + r(t) ∈ X then
        N(x) ← N(x) + 1
        I_{shift}(x) < I_{shift}(x) + Bₜ(x + r(t))
      end if
    end for
    if N(x) > 0 then
      I_{shift}(x) ← I_{shift}(x)/N(x)
    end if
  end for
return I_{shift}(x)
end function
```

As described above, two trajectories are considered: linear and parabolic. Linear trajectories are parameterized by their slope:

$$r ( t ) = v ( t - \frac{T}{2} ) \hat{p} ,$$

where v is the object velocity, \hat{p} is a unit vector that describes the trajectory's direction, and T is the total number of bit-planes. Parabolic trajectories are parameterized by their maximum absolute slope,

$${v}_{max} : r ( t ) = \frac{{v}_{max}}{T} {( t - \frac{T}{2} )}^{2} \hat{p} .$$

To prevent tail-clipping, which are image artifacts introduced by the finite extent of the parabolic integration, vₘₐₓ can be chosen to be higher than the velocity of objects in the scene. Both linear and parabolic trajectories have a zero at t=T/2—which allows blending multiple linear projections without any pixel alignment issues.

$$r ( t ) = v ( t - \frac{T}{2} ) \hat{p} \hat{p} r ( t ) = \frac{{v}_{max}}{T} {( t - \frac{T}{2} )}^{2} \hat{p}$$

What is claimed is:

1. A system for generating multiple modalities of images, comprising:
an image sensor of a first imaging modality;
a processor electrically coupled to the image sensor, the processor programmed to:
receive frame data captured by the image sensor, the frame data comprising a temporal sequence of discrete frames;
determine a desired imaging modality;
perform a projection operation on the frame data;
based on results of the projection operation, generate a post-capture emulation corresponding to the desired imaging modality; and
output an image corresponding to the post-capture emulation.

2. The system of claim 1, wherein the processor is further programmed to compute the projection operation by performing at least one of exposure bracketing, spatio-temporal summation, exposure coding, or temporal contrast filtering on at least a portion of the temporal sequence of discrete frames.

3. The system of claim 1, wherein the desired imaging modality is video compressive sensing and is different than the first imaging modality.

4. The system of claim 3, wherein the processor is further programmed to compute the projection operation by multiplexing at least some of the frame data in a frame-wise fashion via a multi-bucket capture approach, such that the discrete frames are each accumulated to a randomly chosen bucket of a group of k buckets.

5. The system of claim 4, wherein k is four.

6. The system of claim 1, wherein the processor and the image sensor are installed within a single device, such that the processor and image sensor are electrically coupled by a bus.

7. The system of claim 6 wherein:
the device is a camera;
the first imaging modality is that of a high frame rate camera;
the image sensor is the only image sensor of the camera; and
the desired imaging modality is at least one of an event camera; a video compressive sensing camera; or a motion camera.

8. The system of claim 6 wherein:
the device is a sensor; and
the first imaging modality is that of one or more single-photon sensors.

9. The system of claim 1 wherein the desired imaging modality is an event camera.

10. The system of claim 9 wherein the projection operation is computed by thresholding temporal contrast of the frame data.

11. The system of claim 10 wherein thresholding comprises computing a moving average of a plurality of values of discrete frames of the frame data, modifying the moving average by a scalar function, and generating event data when the moving average deviates from a reference by a given threshold.

12. The system of claim 1, wherein the projection operation is computed by performing an exposure bracketing on at least some discrete frames of the frame data.

13. The system of claim 1, wherein the projection operation is computed using at least of one an off-sensor computer, an in-pixel computer, a near sensor computer, and an application specific integration computer (ASIC).

14. The system of claim 1, wherein the desired imaging modality is that of a motion camera.

15. The system of claim 12, wherein the projection operation is computed by performing an integration along one or more trajectories within the frame data.

16. The system of claim 12, wherein the image corresponding to the post-capture emulation has a perspective that exhibits movement of the image sensor that did not actually occur during capture of the frame data.

17. A method for acquiring images of varying modalities via a software-defined camera, the method comprising:
providing a user interface associated with a camera that has a high frame rate sensor;
receiving a user selection of a desired camera emulation from a list of possible camera emulations, the list including at least a first camera modality corresponding to the sensor and a second camera modality different than the first camera modality;
capturing a set of frames via the sensor;
determining at least one projection for the set of frames to produce at least one image that emulates an image from a camera of the second camera modality.

18. The method of claim 17, further comprising computing a projection operation by performing at least one of exposure bracketing, spatio-temporal summation, exposure coding, or temporal contrast filtering on at least a portion of the temporal sequence of discrete frames.

19. The method of claim 17, further comprising computing a projection operation by multiplexing at least some frame data in a frame-wise fashion via a multi-bucket capture approach.

20. The method of claim 18, further comprising thresholding a temporal contrast of frame data.
